(19) United States
(12) Patent Application Publication
(10) Pub. No.: US 2012/0232180 A1
(43) Pub. Date: Sep. 13, 2012

(54) PROCESS FOR THE PRODUCTION OF POLYURETHANE RIGID FOAMS

(75) Inventors: Andreas Kunst, Ludwigshafen (DE); Marc Fricke, Osnabrueck (DE); Markus Schütte, Osnabrueck (DE); Berend Eling, Lemfoerde (DE)

(73) Assignee: BASF SE, Ludwigshafen (DE)

(21) Appl. No.: 13/413,270

(22) Filed: Mar. 6, 2012

Related U.S. Application Data
(60) Provisional application No. 61/450,153, filed on Mar. 8, 2011.

(51) Int. Cl. C08G 18/50; C08G 18/08; C08J 9/06; C08G 18/48; C08J 9/12

(52) U.S. Cl. 521/167; 521/174

(57) ABSTRACT

The present invention relates to a process for the production of polyurethane rigid foams by reaction of polyisocyanates with compounds with at least two hydrogen atoms reactive with isocyanate groups in the presence of propellants.

The present invention relates to a process for the production of polyurethane (PU) rigid foams by reaction of polyisocyanates with compounds with at least two hydrogen atoms reactive with isocyanate groups in the presence of propellants.

For the production of isocyanate-based rigid foams, polyols with high functionality and relatively short chains are normally used in order to ensure optimal crosslinking of the foams. The polyether alcohols preferably used mostly have a functionality of 4 to 8 and a hydroxyl number in the range between 300 to 600, in particular between 400 and 500 mg KOH/g. It is known that polyols with very high functionality and hydroxyl numbers in the range between 300 and 600 have very high viscosity if they are based on propylene oxide. On the other hand, such polyols based on ethylene oxide are up to a quarter less viscous. Further, it is known that such polyols are very polar and thus exhibit poor solubility of hydrocarbons and poor compatibility with polyisocyanates.

An important requirement for rigid foams is shortening of the release time without this causing limitations in the mechanical or processing properties. Further, the starting materials for the production of the rigid foams should exhibit good solubility for the propellant, in particular with use of hydrocarbons as propellants.

Highly functional polyols must not cause any premature curing of the polyurethane system, since otherwise complicated cavities such as arise in particular in cooling devices cannot be completely filled up. The curing behavior of the system used, which also has a marked effect on the cycle times in the manufacture of the appliances, is important for many applications in the rigid foam field, particularly in the insulation of cooling appliances.

From WO98/27132, it can be seen that polyols based on 1,2-butylene oxide exhibit improved solubility for hydrocarbons compared to the corresponding propylene oxide-based polyols.

From WO2006/037540 and WO2008/058863, it is known that polyether alcohols started with toluene diamine (TDA) exhibit particularly good solubility of hydrocarbon-containing propellants. These polyether alcohols are distinguished by relatively low functionality and result in the late curing of the polyurethane system.

The processes for the production of PU rigid foams which are known from the state of the art have a number of shortcomings and mostly cannot fulfill all of the aforesaid requirements.

Hence the purpose of the invention was to overcome the said problems and to provide an improved process for the production of polyurethane rigid foams. At the same time, the system should have optimal flow and curing times and low viscosity of the polyol components which allows processing during production according to the state of the art. In addition, there should be high solubility of the propellants in the system to establish low bulk densities in the building component and the system should have good release properties.

Surprisingly, this problem could be solved through the use of a poly(butylene oxide) polyol (i) with a hydroxyl number from 380 to 500 mg KOH/g and an amine-started polyether alcohol (ii) with a hydroxyl number from 360 to 450 mg KOH/g and optionally a polyether polyol (iii) (so-called “soft polyol”) with a hydroxyl number from 140 to 280 mg KOH/g.

The subject of the present invention is thus a process for the production of polyurethane rigid foams by reaction of

a) at least one polyisocyanate with
b) compounds with at least two hydrogen atoms reactive with isocyanate groups, and
c) at least one propellant,
wherein for the compounds b) with at least two hydrogen atoms reactive with isocyanate groups a mixture of
b1) at least one polyether alcohol with a hydroxyl number from 380 to 500 mg KOH/g, producible by addition of butylene oxide, optionally in combination with at least one further alkylene oxide, to at least one OH or NH functional starter compound with a functionality of 4 to 8 with the aid of a basic catalyst, preferably imidazole,
b2) at least one polyether alcohol with a hydroxyl number from 360 to 450 mg KOH/g, producible by addition of an alkylene oxide to at least one aromatic or aliphatic amine, and
b3) optionally one polyether alcohol with a hydroxyl number from 140 to 280 mg KOH/g, producible by addition of an alkylene oxide to at least one OH or NH functional starter compound,
is used.

Here according to the invention the OH number is determined as per DIN 53240.

Further subjects of the invention are also a polyurethane rigid foam producible by the process according to the invention, and the use of a polyurethane rigid foam producible by the process according to the invention as a thermal insulation material, e.g. in cooling appliances, in hot water tanks, in district heating pipes or in the building and construction industry, for example in sandwich elements.

The poly(butylene oxide)polyol (b1) is produced by normal and generally known methods by ring opening polymerisation of butylene oxide (BO) with the use of multifunctional starter molecules. Possible starter molecules are for example sugar (saccharose), sorbitol, mannose or pentaerythritol (F4-8). In one embodiment, NH or OH group-containing co-starters can be used (e.g. glycerine, TMP, MEG, DEG, MPG, DPG, EDA or TDA).

As well as the butylene oxide isomers 1,2-butylene oxide, 2,3-butylene oxide or isobutylene oxide, other alkylene oxides can also be fed in in the so-called block procedure or also in the mixed procedure. Here, possible comonomers are the generally usual alkylene oxides propylene oxide (PO) and ethylene oxide (EO), 1,2-pentene oxide, styrene oxide, epichlorohydrin, cyclohexene oxide and higher alkylene oxides such as C₅-C₃₀-α-alkylene oxides. However, the use of alkylene oxide mixtures (e.g. PO/EO and BO) is also possible.

As is generally known, the ring opening polymerisation takes place with the aid of catalysts. These are as a rule basic catalysts such as alkali metal or alkaline earth metal hydroxides or alkali metal or alkaline earth metal alcoholates (e.g. NaOH, KOH, CsOH or sodium methylate, potassium methylate). Further, catalysts which contain amino-containing functional groups (e.g. DMEOA or imidazole) can be used for the alkoxylation. Further, the use of carbenes as alkoxylation catalysts is possible.

In one embodiment of the process according to the invention for the production of polyurethane rigid foams, the catalyst usable for the production of the poly(butylene oxide)polyol (b1) is selected from the group comprising amino-functional catalysts. In one embodiment, the catalyst usable for the production of the poly(butylene oxide)polyol (b1) is selected from the group comprising trimethylamine, triethylamine, tripropylamine, N,N′-dimethylethanolamine, N,N′-dimethylcyclohexylamine, dimethylethylamine, dimethylbutylamine, N,N′-dimethylaniline, 4-dimethylaminopyridine, N,N′-dimethylbenzylamine, pyridine, imidazole, N-methylimidazole, 2-methylimidazole, 4-methylimidazole, 5-methylimidazole, 2-ethyl-4-methylimidazole, 2,4-dimethylimidazole, 1-hydroxypropylimidazole, 2,4,5-trimethylimidazole, 2-ethylimidazole, 2-ethyl-4-methylimidazole, N-phenylimidazole, 2-phenylimidazole, 4-phenylimidazole, guanidine, alkylated guanidines, 1,1,3,3-tetramethylguanidine, 7-methyl-1,5,7-triazabicyclo[4.4.0]dec-5-ene, 1,5-diazabicyclo[4.3.0]non-5-ene and 1,5-diazabicyclo[5.4.0]undec-7-ene.

The said usable amine catalysts can be used alone or in any mixtures with one another. In a preferred embodiment of the invention, the catalyst usable for the production of (b1) is dimethylethanolamine.

In a further preferred embodiment of the invention, the catalyst usable for the production of (b1) is selected from the group of the imidazoles, particularly preferably imidazole.

In one embodiment of the process according to the invention for the production of polyurethane foams, the amine-started polyol (b2) is produced by alkylene oxide addition to aromatic amines such as for example vicinal toluene diamine, methylene dianiline (MDA) and/or polymeric methylene dianiline (pMDA).

In one embodiment of the process according to the invention for the production of polyurethane foams, the amine-started polyol (b2) is produced by alkylene oxide addition to aliphatic amines such as for example ethylenediamine.

In one embodiment of the process according to the invention for the production of polyurethane foams, the optional polyol (b3) with a hydroxyl number from 140 to 280 mg KOH/g is selected from the group comprising alkylene oxide addition products of sugar, glycerine, ethylene glycol, diethylene glycol, propylene glycol, dipropylene glycol, 1,4-butanediol, pentaerythritol, trimethylolpropane, water, sorbitol, aniline, TDA, MDA, EDA or combinations of the said compounds, preferably glycerine, ethylene glycol, diethylene glycol, propylene glycol and dipropylene glycol.

Here also, the addition of the alkylene oxides takes place by the generally usual processes with the use of catalysts. For the production of the polyols (b2) and (b3), in principle all catalysts which are also usable for the production of the poly(butylene oxide)polyols (b1) are usable.

The ring opening polymerisation for the production of the polyols (bi), (bii) and (biii) takes place under usual reaction conditions in the temperature range between 90 and 160° C., preferably between 100 and 130° C. at pressures in the range between 0 and 20 bar, preferably between 0 and 10 bar.

The addition of the alkylene oxides for the production of the polyols (b1), (b2) and (b3) can take place in the semi-batch process or even completely continuously or semicontinuously. In a further embodiment, a certain proportion of product or preproduct is also placed in the reactor in addition to the starter mixture (Heel process).

After completion of the addition of the alkylene oxides, the polyols are as a rule worked up by usual methods, in that unreacted alkylene oxides and volatile components are removed, usually by distillation, steam or gas stripping and/or other deodorization methods. If necessary, a filtration can also be performed.

The poly(butylene oxide)polyol (b1) is distinguished by OH numbers in the range from 380 to 500 mg KOH/g, preferably from 300 to 500 mg KOH/g.

The amine-started polyether alcohol (b2) is distinguished by OH numbers in the range from 360 to 450 mg KOH/g.

The functionality of the poly(butylene oxide)polyols (b1) is determined by the functionality of the starter mixture and lies in the range between 3.5-8, preferably between 4-6 OH groups/molecule.

The viscosities of the polyetherols (b1), (b2) and (b3) lie in the usual ranges for this OH number range between 100 and 50 000 mPas, preferably between 200 and 30 000 mPas.

The viscosity of the poly(butylene oxide)polyol (b1) preferably lies between 5000 and 30 000 mPas.

In one embodiment of the process according to the invention for the production of polyurethane rigid foams, the at least one polyisocyanate (a) is selected from the group comprising aromatic, aliphatic and/or cycloaliphatic diisocyanates, for example diphenylmethane diisocyanate (MDI), polymeric MDI (pMDI), toluene diisocyanate (TDI), tri-, tetra-, penta-, hexa-, hepta- and/or octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate, 4,4′-, 2,4′- and/or 2,2′-dicyclohexylmethane diisocyanate, preferably TDI, MDI and/or pMDI.

In one embodiment of the process according to the invention for the production of PU rigid foams, the at least one propellant (c) is selected from the group comprising physical propellants and chemical propellants.

Preferably exactly one physical and exactly one chemical propellant is used.

In combination with or instead of chemical propellants, physical propellants can also be used. These are compounds inert towards the components used, which are mostly liquid at room temperature and evaporate under the conditions of the urethane reaction. Preferably, the boiling point of these compounds lies below 50° C. The usable physical propellants also include compounds which are gaseous at room temperature and are introduced into the components used or dissolved in them under pressure, for example carbon dioxide, low-boiling alkanes and fluoroalkanes.

The physical propellants are mostly selected from the group comprising alkanes and/or cycloalkanes with at least 4 carbon atoms, dialkyl ethers, esters, ketones, acetals, fluoroalkanes with 1 to 8 carbon atoms, and tetraalkylsilanes with 1 to 3 carbon atoms in the alkyl chain, in particular tetramethylsilane.

In one preferred embodiment of the invention, the propellants (c) are hydrocarbons. Particularly preferably, the propellants are selected from the group comprising alkanes and/or cycloalkanes with at least 4 carbon atoms. In particular, pentanes, preferably isopentane and cyclopentane, are used. With the use of the rigid foams as insulation in cooling appliances, cyclopentane is preferred. The hydrocarbons can be used mixed with water.

As examples of propellants (c) usable according to the invention, propane, n-butane, iso- and cyclobutane, n-, iso- and cyclopentane, cyclohexane, dimethyl ether, methyl ethyl ether, methyl butyl ether, methyl formate and acetone may be mentioned, and also fluoroalkanes which can be degraded in the troposphere and thus are harmless to the ozone layer, such as trifluoromethane, difluoromethane, 1,1,1,3,3-pentafluorobutane, 1,1,1,3,3-pentafluoropropane, 1,1,1,2-tetrafluoroethane, difluoroethane and 1,1,1,2,3,3,3-heptafluoropropane, and perfluoroalkanes such as C₃Fa, C₄F₁₀, C₅F₁₂, C₆F₁₄ and C₇F₁₆. The said physical propellants can be used alone or in any combination with one another.

Further, hydrofluoro olefins, such as 1,3,3,3-tetrafluoropropene, or hydrochlorofluoro olefins, such as 1-chloro-3,3,3-trifluoropropene, can be used as propellants. Such propellants are for example described in WO 2009/048826.

In a preferred embodiment, water, which reacts with isocyanate groups with release of carbon dioxide, is used as a chemical propellant. As a physical propellant for example formic acid can also be used.

If necessary, the production of the polyurethane rigid foams according to the invention can be performed in the presence of catalysts, flame retardants and normal auxiliary and/or additive substances.

As catalysts, compounds which strongly accelerate the reaction of the isocyanate groups with the groups reactive with the isocyanate groups are in particular used. Such catalysts are strongly basic amines such as for example secondary aliphatic amines, imidazoles, amidines, and alkanolamines or organic metal compounds, in particular organic tin compounds.

If isocyanurate groups are also to be incorporated into the polyurethane rigid foam, special catalysts are needed for this. As isocyanurate catalysts, metal carboxylates, in particular potassium acetate and solutions thereof, are normally used.

Depending on the requirement, the catalysts can be used alone or in any mixtures with one another.

As auxiliary agents and/or additives for this purpose, substances known per se, for example surface-active substances, foam stabilizers, pore regulators, fillers, pigments, dyes, flame retardants, antihydrolytic agents, antistatic agents, and agents with fungistatic and bacteriostatic action may be used.

Further information on starting compounds used can for example be found in the Kunststoffhandbuch, Vol. 7, “Polyurethanes”, published by Gunter Oertel, Carl-Hanser-Verlag, Munich, 3rd Edition, 1993.

The invention will be illustrated in more detail in the following example. However the example is intended to illustrate only one aspect of the invention and is not to be regarded as in any way restrictive of the scope of the invention.

Raw Materials Used:

Polyol A: polyether alcohol from saccharose, glycerine and propylene oxide, functionality 5.1, hydroxyl number 450, viscosity 18 500 mPa·s at 25° C.

Polyol B: polyether alcohol from vicinal TDA, ethylene oxide and propylene oxide, ethylene oxide content: 15%, functionality 3.8, hydroxyl number 390, viscosity 13 000 mPa·s at 25° C.

Polyol C: polyether alcohol from vicinal TDA, ethylene oxide and propylene oxide, ethylene oxide content: 15%, functionality 3.9, hydroxyl number 160, viscosity 650 mPa·s at 25° C.

Polyol D: dipropylene glycol

Production of Polyol E (According to the Invention)

5936 g of saccharose, 1800 g of glycerine and 41 g of water are placed in a pressure autoclave and treated with 118 g of a 48% aqueous KOH solution. After the reaction mixture has been inerted three times with nitrogen, the reaction mixture is freed from water under vacuum at 15 mbar for ca. 90 minutes at 130° C. Next, 17 143 g of 1,2-butylene oxide are fed in at a feed rate of 2 kg/hr. After completion of the monomer feed and attainment of a constant reactor pressure, unreacted 1,2-butylene oxide and other volatile components are distilled off under vacuum and the product drained out. The product is then treated with 2% Macrosorb® (alumosilicate-based absorbent) and 5% water and stirred for 2 hrs at 130° C. After removal of the added water by vacuum distillation and subsequent filtration, 25 000 g of the desired polyetherol are obtained in the form of a brown colored, viscous liquid.

Analysis:

| | |
|---|---|
| OH number = 461 mg KOH/g | (DIN 53240) |
| Viscosity = 23 234 mPas | (DIN 13421) |
| Acid number = 0.02 mg KOH/g | (DIN 53402) |
| Water value = 0.024% | (DIN 51777) |

Stabilizer: Tegostab® B 8491 (silicone stabilizer from Evonik)
Catalyst 1: dimethylcyclohexylamine (BASF SE)
Catalyst 2: pentamethyl diethylenetriamine (BASF SE)
Catalyst 3: Lupagren® N600 (s-triazine) (BASF SE)
Isocyanate: polymeric MDI (Lupranat® M20, BASF SE)

Machine foaming:

A polyol component was produced from the stated raw materials. By means of a high pressure Puromat® PU 30/80 IQ (BASF Polyurethanes GmbH) with a discharge rate of 250 g/sec, the polyol component was mixed with the necessary quantity of the stated isocyanate, so that an isocyanate index (unless otherwise stated) of 116.7 was reached. The reaction mixture was injected into temperature-controled extruder dies of dimensions 2000 mm×200 mm×50 mm and 400 mm×700 mm×90 mm respectively and there allowed to expand. The overfill was 15%.

| | | 2 (acc. to |
|---|---|---|
| | 1 | invention) |
| Polyol component | | |
| Polyol A (parts by weight) | 54 | |
| Polyol B (parts by weight) | 22 | 22 |
| Polyol C (parts by weight) | 15 | 15 |
| Polyol D (parts by weight) | 2 | 2 |
| Polyol E (acc. to invention) (parts by weight) | | 54 |
| Water (parts by weight) | 2.6 | 2.6 |
| Stabilizer (parts by weight) | 2.7 | 2.7 |
| Catalyst (parts by weight) | 1.7 | 1.7 |
| Cyclopentane (parts by weight) | 13 | 13 |
| Isocyanate component | | |
| Isocyanate (parts by weight) | 133 | 133 |
| Setting time [secs] | 37 | 35 |
| Free volume weight [g/l] | 24.0 | 24.0 |
| Polyol component viscosity [mPas @ 25° C.] | 6800 | 7400 |
| Minimal fill density [g/l] | 31.8 | 32.4 |
| Flow factor (min. fill density/free bulk density) | 1.33 | 1.31 |
| Thermal conductivity [mW/m * K] | 19.1 | 18.9 |
| Compressive strength [N/mm²] | 15.9 | 15.7 |
| Core bulk density [g/l] | 33.2 | 32.6 |
| After-expansion after 24 hrs [mm] (%) | | |
| 3 mins | 4.8 | 3.6 |
| 4 mins | 3.2 | 2.3 |
| 5 mins | 2.2 | 1.5 |
| 7 mins | 1.0 | 0.6 |
| Phase stability | homo- | homogeneous |
| | geneous | |

Example 1 is a comparative example. The system in example 2 (according to the invention) with a polyether alcohol based on saccharose, glycerine and butylene oxide has markedly better release properties, which manifest themselves in a low after-expansion. Hence it could be shown that the process according to the invention leads to improved properties.

1. A process for the production of polyurethane rigid foams by reaction of
a) at least one polyisocyanate with
b) compounds with at least two hydrogen atoms reactive with isocyanate groups, and
c) at least one propellant,
wherein for the compounds b) with at least two hydrogen atoms reactive with isocyanate groups a mixture of
b1) at least one polyether alcohol with a hydroxyl number from 380 to 500 mg KOH/g, producible by addition of butylene oxide, optionally in combination with at least one further alkylene oxide, to at least one OH or NH functional starter compound with a functionality of 4 to 8 with the aid of a basic catalyst,
b2) at least one polyether alcohol with a hydroxyl number from 360 to 450 mg KOH/g, producible by addition of an alkylene oxide to at least one aromatic or aliphatic amine, and
b3) optionally at least one polyether alcohol with a hydroxyl number from 140 to 280 mg KOH/g, producible by addition of an alkylene oxide to at least one OH or NH functional starter compound,
is used.

2. The process according to claim 1, wherein the OH or NH functional starter compound in b1) is selected from the group comprising saccharose, sorbitol, mannose and pentaerythritol, glycerine, trimethylolpropane, ethylene glycol, diethylene glycol, propylene glycol, dipropylene glycol, neopentyl glycol, 1,4-butanediol, water, toluene diamine, methylene dianiline, polymeric methylene dianiline and ethylenediamine.

3. The process according to claim 1 or 2, wherein the alkylene oxide in b2) is selected from the group comprising 1,2-pentene oxide, propylene oxide, ethylene oxide or mixtures thereof.

4. The process according to claim 3, wherein an aromatic amine is used in b2).

5. The process according to claim 4, wherein the aromatic amine in b2) is selected from the group comprising toluene diamine (TDA), methylene dianiline (MDA) and polymeric methylene dianiline (pMDA).

6. The process according to claim 1 or 2, wherein an aliphatic amine is used in b2).

7. The process according to claim 6, wherein the aliphatic amine in b2) is selected from the group comprising ethylenediamine, 1,3-propylene diamine, 1,4-butylene diamine, monoethanolamine, diethanolamine, monoisopropanolamine and diisopropanolamine.

8. The process according to one of claims 1 to 7, wherein the polyether polyol b3) is present.

9. The process according to claim 8, wherein the alkylene oxide in b3) is selected from the group comprising 1,2-pentene oxide, propylene oxide, ethylene oxide or mixtures thereof.

10. The process according to one of claim 8 or 9, wherein the OH or NH functional starter compound in b3) is selected from the group comprising saccharose, glycerine, ethylene glycol, diethylene glycol, propylene glycol, dipropylene glycol, 1,4-butanediol, pentaerythritol, trimethylolpropane, water, sorbitol, aniline, TDA, MDA, EDA and combinations of the said compounds.

11. The process according to one of claims 1 to 7, wherein the polyether polyol b3) is not present.

12. The process according to one of claims 1 to 11, wherein the content of the component b1) based on b) is between 40 and 60 wt. %.

13. The process according to one of claims 1 to 12, wherein the content of the component b2) based on b) is between 20 and 40 wt. %.

14. The process according to one of claims 1 to 13, wherein the basic catalyst under b1) is selected from the group comprising amino-functional catalysts.

15. The process according to one of claims 1 to 14, wherein the polyisocyanate a) is selected from the group comprising aromatic, aliphatic and cycloaliphatic diisocyanates.

16. The process according to one of claims 1 to 15, wherein the propellant c) is selected from the group comprising physical propellants and chemical propellants.

17. A polyurethane rigid foam, producible by the process of one of claims 1 to 16.

18. The use of a polyurethane rigid foam producible by the process of one of claims 1 to 16 as thermal insulation material in cooling appliances, in hot water reservoirs, in district heating pipes or in the building and construction industry.
